(19) United States
(12) Patent Application Publication
(10) Pub. No.: US 2015/0039386 A1
(43) Pub. Date: Feb. 5, 2015

(54) METHOD AND SYSTEM FOR RISK ASSESSMENT ANALYSIS

(71) Applicant: Omnex Systems, LLC, Ann Arbor, MI (US)

(72) Inventors: Chandran Kymal, Ann Arbor, MI (US); Gregory Francis Gruska, Farmington Hills, MI (US)

(73) Assignee: Omnex Systems, LLC, Ann Arbor, MI (US)

(21) Appl. No.: 13/957,947

(22) Filed: Aug. 2, 2013

(51) Int. Cl. G06Q 10/06

(52) U.S. Cl. CPC G06Q 10/0635
USPC 705/7.28

(57) ABSTRACT

An engineering management system including one or more processors configured to receive input defining one or more requirements for a product. The engineering management system may generate a first risk prevention document based on one or more of the product requirements and receive risk parameter input related to the first risk prevention document. The engineering management system may initiate a problem solver analysis tool based on the first risk prevention document and receive problem parameter input related to the problem solver analysis tool. The engineering management system may determine one or more outputs using the problem solver analysis tool. The engineering management system may populate one or more aspects of the first risk prevention document with the determined outputs based on one or more defined associations between the first risk prevention document and the problem solver analysis tool.

### TECHNICAL FIELD

The illustrative embodiments generally relates to methods and systems for knowledge management throughout the entire life cycle of a product for use in product and process optimization, problem solving, and the development of other products and services.

### BACKGROUND

There are several disciplines that may have different perspectives used to problem solve one or more issues discovered in a product, process, or system. These disciplines may consist of methods that have different approaches and philosophies for finding solutions to problems. The problem solving discipline methods may be classified into two different types of categories including unstructured and structured solution path methods. The unstructured problem solving path may include methods and techniques that may help identify the root cause of a problem with an indeterminate defined solution path. The structured problem solving solution path will include techniques that help analyze the problem and yield well defined solutions and specific goals.

An eight discipline (8D) problem solving method is an example of a structured approach to resolve problems even those that may have an ill-defined solution path. The eight discipline problem solving approach identifies, corrects, and eliminates recurring problems and may be useful in product and process improvements. The result of an eight discipline problem solving method is to establish a permanent corrective action based on statistical analysis of the problem and focuses on the origin of the problem by determining its root causes. The eight disciplines are included as followed: plan for solving the problem, establish a team of people, specify the problem by identifying in quantifiable terms the who, what, where, when, why, how and how many, define and implement containment actions to isolate the problem, identify all applicable causes that could explain why the problem has occurred, confirm the selected correction will resolve the problem, define, verify, and implement the best corrective actions to prevent recurrence of the problem, modify the systems, operation systems, practices, and procedures to prevent occurrence of the problem in other areas, and congratulate the team.

A failure mode and effect analysis (FMEA) solving method is an approach to systematically study problems that might arise from malfunctions of one or more components and/or systems. An FMEA is often the first step of a system reliability study or risk analysis when developing a new product, process, or system. It involves reviewing components, assemblies, and subsystems to identify failure modes, their causes and effects, detection and preventive controls and improvement actions. For each component, the failure modes and their resulting effects on the rest of the system are recorded in a specific FMEA worksheet. A few different types of FMEA analysis exist, for example a System, Design and Process FMEA.

The use of problem solving and/or risk prevention analysis includes a problem definition, indication of root causes, corrective action or solutions, and/or corrective actions to prevent that type of problem in other product lines or manufacturing locations. The information collected using the problem solving and/or risk prevention analysis tools may be useful for related products and/or future development of next generation products. Using these methods and tools during early development of a product is called risk assessment, and later in the product life cycle is called problem solving.

### SUMMARY

In a first illustrative embodiment, an engineering management system having one or more processors configured to receive input defining one or more requirements for a product. The engineering management system may generate a first risk prevention document based on one or more of the product requirements and receive risk parameter input related to the first risk prevention document. The engineering management system may initiate a problem solver analysis tool based on the first risk prevention document and receive problem parameter input related to the problem solver analysis tool. The engineering management system may determine one or more outputs using the problem solver analysis tool. The engineering management system may populate one or more aspects of the first risk prevention document with the determined one or more outputs based on one or more defined associations between the first risk prevention document and the problem solver analysis tool.

In a second illustrative embodiment, a non-transitory machine readable storage medium storing instructions that, when executed, cause a processor to perform a method of receiving input defining one or more requirements for a product. The method may generate a first risk prevention document based on one or more of the product requirements. The method may receive risk parameter input related to the first risk prevention document and initiate a problem solver analysis tool based on the first risk prevention document. The method may receive problem parameter input related to the problem solver analysis tool and determine one or more outputs using the problem solver analysis tool. The method may populate one or more aspects of the first risk prevention document with the determined one or more outputs based on one or more defined associations between the first risk prevention document and the problem solver analysis tool.

In a third illustrative embodiment, a quality management method of receiving input defining one or more requirements for a product. The method may generate a first risk prevention document based on one or more of the product requirements. The method may receive risk parameter input related to the first risk prevention document and initiating a problem solver analysis tool based on the first risk prevention document. The method may receive problem parameter input related to the problem solver analysis tool and determine one or more outputs using the problem solver analysis tool. The method may populate one or more aspects of the first risk prevention document with the determined outputs based on one or more defined associations between the first risk prevention document and the problem solver analysis tool.

### BRIEF DESCRIPTION OF THE DRAWINGS

FIG. 1 is a diagram of a web-based software system architecture for knowledge management of several analysis tools used for product development;

FIG. 2A is a flow chart for a risk management process using one or more analysis tools while referencing design and specification requirements;

FIG. 2B is a flow chart for a system allowing problem solving and risk assessment information to be transmitted between several method and analysis tools;

FIG. 3 is a flow chart for a quality management system and process generates and identifies root cause problem analysis and transmits the information to a failure mode effects analysis;

FIG. 4 is a block flow diagram illustrating a preferred implementation of process knowledge management in accordance with one embodiment or aspect of present invention;

FIG. 5 is a flow chart for a quality management system that generates risk analysis documents with the integration of problem solving analysis methods for root cause investigation;

FIG. 6 is an exemplary block topology of a quality management system implementing a multiple user-interactive display system;

FIG. 7 is an example GUI for identifying a potential cause of failure in a risk analysis document that requires information to identify controls and root cause with the option of launching a problem solver from the document to perform additional analysis;

FIG. 8 is an example GUI which is the result of launching a problem solver from a risk analysis document to start root cause analysis;

FIG. 9 is an example GUI for auto-populating information into the problem solver tool from the risk analysis document; and

FIG. 10 is an example GUI for merging information from the problem solver document to one or more risk analysis documents and publishing a link indicated by an icon to cross reference the documents.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Engineers may use several spreadsheets to identify and analyze risks associated with their designs and processes. The spreadsheets may be developed to include several analysis tools including, but not limited to, the eight discipline problem solving method steps (or analogous problem solving strategy), design of experiments, tolerance design, quality function deployment and/or categories to determine a proper failure mode and effects analysis. A software application may be designed to implement one or more analysis tools to ensure a consistent organized approach when completing the analysis method.

The software application may implement the one or more analysis tools while also managing engineering design records and specification requirements for the one or more products that an engineering organization may be developing. The engineering design records and specification requirements may be managed by using the production part approval process (PPAP) method and/or the advanced product quality planning process (APQP) designed to ensure that a product is consistently meeting requirements during an actual production run. The PPAP and APQP methods ensure that suppliers and OEMs have properly understood all the design and specification requirements for one or more components and that the process has the capability to consistently deliver products that comply with those requirements.

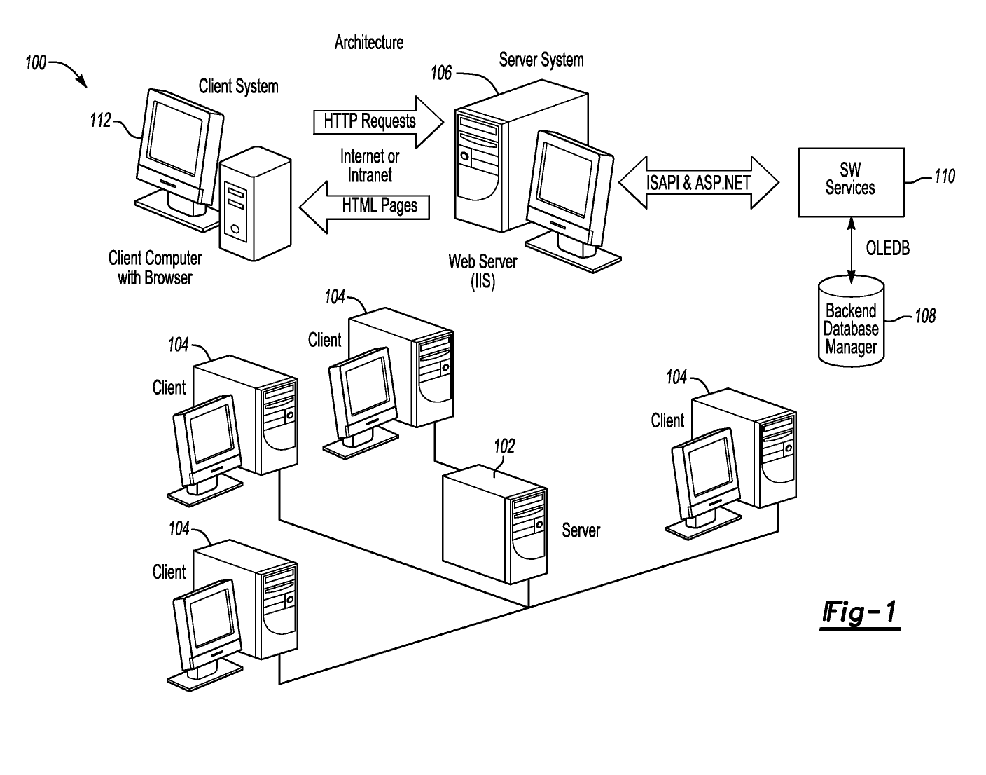

In one embodiment, as shown in FIG. 1, is a diagram of a web-based software system architecture for knowledge management of several analysis tools used for product development. The web-based software system 100 may include a management method that integrates PPAP and/or APQP documents while allowing one or more analysis tools to be implemented while enabling data sharing between documents.

For example, the system architecture may be a web-based software working over an internet and/or intranet allowing worldwide access to one or more facilities across the globe. The primary requirements of the sites are that they have access to the host location. The software resides on the host location which is located on a customer server with access to a SQL manager and any computer that has a browser with access to the internet and/or intranet. The system architecture may allow a user to create an enterprise specific knowledge bank allowing for customized reports to meet a specific customer requirement and also provide a detailed revision history on all PPAP, APQP, and/or analysis tools documentation.

The system architecture 100 network diagrams may include, but is not limited to, a server 102, one or more processors, one or more client systems 104, and software that may be designed to be a standalone system. The one or more client systems 104 may be located at an individual user site having a single office, or several offices globally located.

The system architecture 100 may include, but is not limited to, a webserver 106, a database 108, knowledge management software 110, and one or more client systems 112. The webserver 106 having a processor, RAM, a hard disk drive, and the necessary server software. The database system 108 may include, but is not limited to, a relational database management system (e.g. Microsoft SQL server) having a processor, RAM, a hard disk, and an operating system software. The one or more client systems 112 having at least a processor, RAM, browser, and internet/intranet software requirements.

The knowledge management software 110 may be a standalone design using only a database system as the backend database manager. The knowledge management system software may include application programming interfaces (APIs) allowing software components to interact with each other. The knowledge management system software may communicate with other software via a set of rules for encoding documents in a format that is both human-readable and machine-readable (e.g. extensible markup language (XML)). The software may include, but is not limited to using and/or creating: product and process requirements, malfunctions and failure modes of the requirements, effects of the failure modes, preventive controls, detective controls, recommended actions and implementation timings, control (test and detection activities) implementation details and results, project timings and supporting documentation, product details related to FMEAs, problem details related to global 8D method, and final solution and validation results.

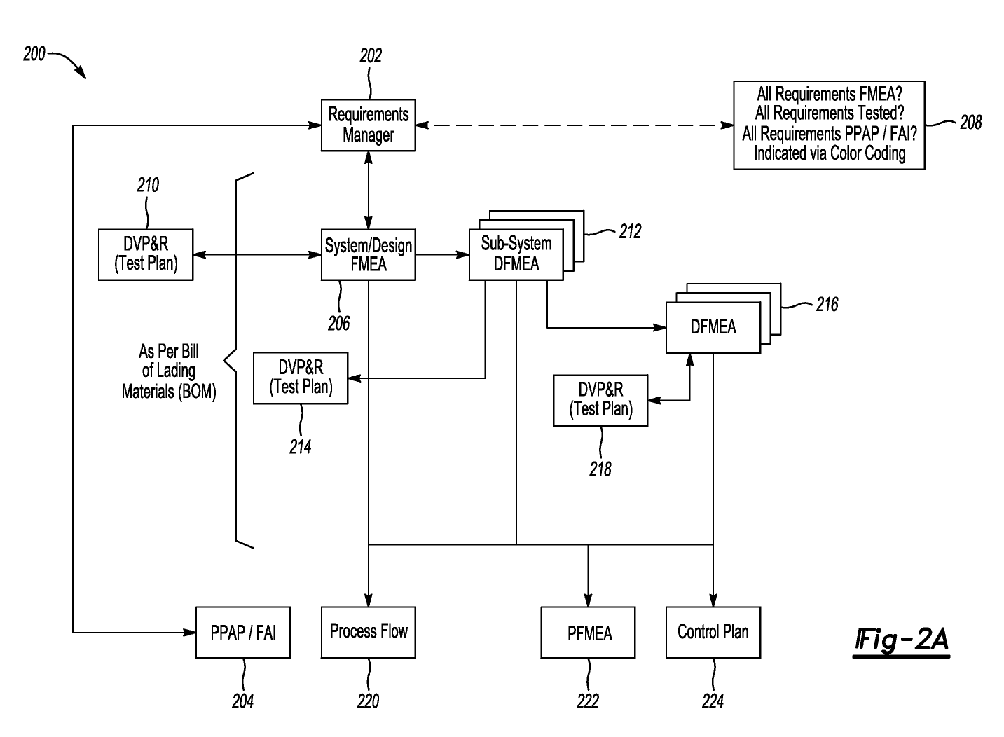

FIG. 2A is a flow chart for a risk management process 200 using one or more analysis tools while referencing design and specification requirements. The one or more analysis tools may include, but is not limited to, system and/or design FMEAs; design verification plan and report (DVP & R); first article of inspection (FAI); and/or a hazard analysis risk assessment (HARA). The design and specification requirement documents may include, but is not limited to PPAPs, APQPs, and/or a first article of inspection (FAI). The FAI may include, but is not limited to testing results of production parts to determine if the product meets acceptance requirements and quality control requirements.

At step 202, the requirements manager may be displayed to one or more client system computers and allows a user access to all analysis results and requirements. The requirement manager may receive PPAP, APQP, and/or FAI information at step 204. The risk management process may receive the requirements from one or more users at a client computer. The requirement manager may receive one or more FMEA(s) analysis information at step 206. The risk management process may allow a user to access and administer an FMEA at one or more client computers.

At step 208, the requirements manager may present the analysis and requirements information to a user using several formats including, but not limited to, a dashboard display. The dashboard display may present all requirements with the respective analysis done in the FMEA and/or 8D based on user defined relationships of color coding on what is complete and pending. For example, the dashboard may let a user know if all the requirements have been analyzed in the FMEA using color coding. In another example, the dashboard may also present information related to the testing results of all the requirements and/or present all the PPAP requirements related to the FIA.

At step 206, the requirements manager is able to replicate the product requirements into one or more FMEAs. The product requirements may include, but is not limited to, PPAP and/or APQP. The one or more FMEAs may include design and/or system FMEAs. The process allows information to be entered automatically eliminating the need to rework, re-enter, edit, and/or review multiple analytical tool documents/spreadsheets. The requirements generated into FMEAs may be all or only safety product requirements.

At step 210, the process may allow the FMEAs to be compared and analyzed to the several test performed on the product. The several tests performed on the product may be summarized using a design verification plan and report form (DVP & R). The DVP & R is a summary of every test performed on the product and/or system, and identified in the related system or design FMEA. The DVP & R may include, but is not limited to, each individual test, when the test was performed, the requirement tested, results, and if the test passed/failed. The DVP & R allows for the product/system bill of materials to be listed with the requirements to show compliance to the specification. Typically the DVP & R are reviewed and signed off by both customer and supplier engineering groups.

At step 212, the process may develop a subsystem FMEA to determine the cause and effect relationship between that subsystem and the product/system as a whole. The subsystem FMEA may include a design FMEA. The process may allow the subsystem FMEA to be compared, correlated, and analyzed to the subsystem DVP & R at step 214. The subsystem DVP & R may include, but is not limited to, each individual test performed on the subsystem, the requirement tested, results and if the test passed/failed. The DVP & R information is transmitted and correlated with the subsystem FMEA.

At step 216, the process may also develop a component FMEA which may be embedded in the system/product and/or the subsystem. The component FEMA may include a design FMEA. The process may allow the component FMEA to be compared, correlated and analyzed to the component DVP & R at step 218. The component DVP & R may include, but is not limited to, each individual test performed on the component, the requirement tested, results and if the test passed/failed. The component DVP & R information is transmitted and correlated with the component FMEA.

At step 220, a process flow diagram is generated based on the general flow of the manufacturing and/or assembly process and equipment based on the product. The process flow diagram displays the relationship between the equipment and/or assembly operation of processing the product.

At step 222, a process FMEA is generated that includes analysis of a sequence of tasks that is organized to produce a product or provide a service. The process FMEA can involve analysis with several sequences of tasks including, but not limited to, fabrication, assembly, transactions, or services.

At step 224, a control plan is generated to keep track of the status of all significant process characteristics. The control plan is used in developing controls against unfavorable outcomes in a manufacturing process. Based on the FMEAs, the control plan determines what steps to take if a specific failure becomes apparent and is a tool to control and contain warrant issues. The control plan may also be used as a tool to coordinate future and ongoing process improvement activities.

FIG. 2B is a flow chart for a system allowing problem solving and risk assessment information to be transmitted between several method and analysis tools. The system may allow several risk prevention and/or problem solving tools to transmit and receive information that may be relevant and/or related to that respective document. For example, a problem solving document may determine one or more root causes for a problem that may be acknowledged in several risk assessment documents, therefore the root cause may be transmitted and recorded in the risk assessment documents.

The risk prevention and problem solving tools may include, but is not limited to, an FMEA, 8D, A3, 5 Why, and/or a design of experiment (DOE). The risk prevention tools may also include other tools that seek to prevent risk early in the design life cycle. The system 201 enables these tools or methods to be used to identify a risk/problem, determine a root cause and solution while allowing the information to be passed through to the other methods, analysis and tools. The information passed ensures the data recorded can be shared to all of the other products associated with the analysis done using the risk prevention methods and problem solving tools.

At step 230, the system may be used as a risk prevention tool allowing an FMEA to be enabled for risk analysis for the development of a product or during the products life cycle. During the implementation of an FMEA, the user may have one or more problems that may need root cause analysis performed at step 232. If the root cause is known, the user and/or system may populate the known root cause into the FMEA. If the root cause is unknown, the user and/or system may allow a disciplined problem solving tool to be enabled at step 234.

The problem solving tool may be able to determine the root cause at step 234. The system may determine if a root cause is found using the disciplined problem solving tool at step 236. If the root cause is still unknown, the user and/or system may allow a design of experiment analysis be enabled at step 238.

The system may allow communication between the one or more analysis tools for populating information relevant between the risk analysis, problem solving, and/or design or experiment documents. The system may also allow the sequence of steps to begin with the launching of a design of experiment and allowing the results from the DOE to be populated to the other risk analysis and problem solving tools.

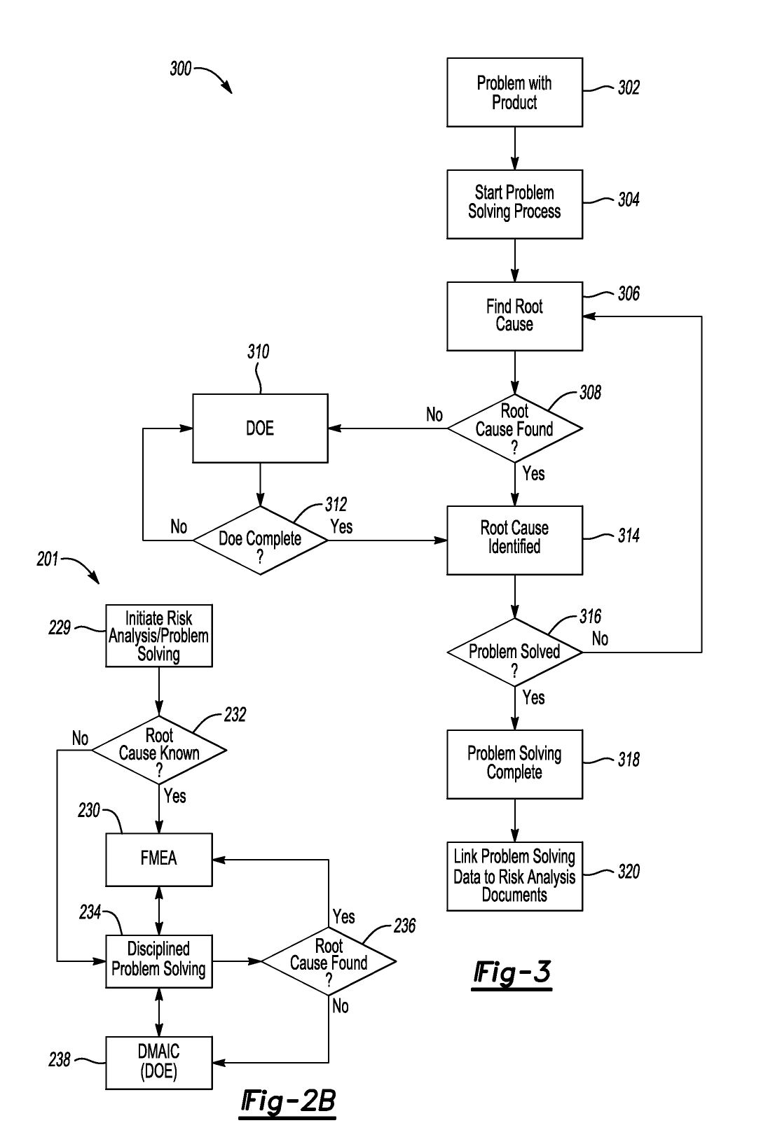

FIG. 3 is a flow chart for an engineering management system and process 300 that generates and identifies root cause problem analysis and transmits the information to a risk assessment document (e.g. failure mode effects analysis). A problem can be initiated in a product that may have not been identified during the failure mode effects analysis stage during development. The problem solver analysis results may typically be stored on a separate system and/or database from where the risk assessment documentation is located. The engineering management system allows for the problem solver analysis tools to be implemented and stored with the ability to coordinate and associate the respective information to related FMEAs.

In current engineering environments one or more groups located in different facilities may be working on a problem discovered in a product. For example, a problem may be discovered in the assembly plant that may cause the manufacturing engineers and the product engineers to begin root causing the problem. The manufacturing engineers and product engineers may be located in different facilities located in different countries. The manufacturing engineers may come up with a solution and for lack of tools, not communicate the solution to the product development engineers who may be implementing this product at another manufacturing facility which may also have this problem show up during production. A management system may be needed to allow one or more groups to communicate risk analysis results, problem solving analysis, and improvements to other organizations and product development teams. This may eliminate redundant work, and improve the quality of the current and future products developed.

At step 302, a problem may be discovered in a system, subsystem, and/or component of a product or service. The problem may be an issue that was not discovered during the product, system, subsystem, and/or component failure mode effect analysis and related preventive and detective controls. The engineering management process may begin one or more root cause analysis tools to solve the product or service problem at step 304. The one or more problem solving analysis tools may include, but it is not limited to, a global eight discipline (8D) analysis, A3, 5 Why, team oriented problem solving, five phase analysis, corrective and preventive action, and/or rapid problem resolution.

At step 306, the problem solving analysis method (e.g. 8D) may allow for several determined outcomes including, but not limited to, one or more short term corrective actions potentially leading to identify the root cause of the problem. The root cause may be identified after minimal analysis, however if the root cause is not easily identifiable other analysis tools and method are required at step 308.

At step 310, if the root cause is not found, a problem solver may initiate a design of experiment (DOE) and/or a Six Sigma (DMAIC) information gathering and problem solving exercise to determine the root cause. During the DOE and or DMAIC analysis, the problem solver may have to add additional arising variables before determining control and intervening relationship between the variables at step 312.

At step 314, once the DOE and/or potential root cause analysis is complete, the problem solver may have identified the root cause of the problem. The results of the DOE and potential root cause corrective actions is implanted to verify if the problem has been solved at step 316. If the potential corrective action has not fixed the problem, the problem solver may have to perform additional problem solving analysis back at step 306.

If the problem solving analysis method has identified the root cause of the problem and the fix has been verified, a permanent corrective action is implemented. After verification of the permanent corrective action is implemented, the problem solving analysis method is complete at step 318.

At step 320, the relevant information collected, analyzed, and generated during the problem solving analysis method may be communicated to one or more risk analysis documentation (e.g. FMEA). For example, one or more FMEAs may be updated with the 8D data to ensure the quality improvement for current and future products. The relevant information from the 8D to one or more FMEAs may include, but is not limited to, additional requirements for the product and/or process, potential failure modes, potential effects of failure, severity ranking of failure, potential causes of failure, add/update in the occurrence ranking, root causes, preventive controls, detective controls, add/update detection ranking, and/or add a new risk priority number.

The engineering management system transmits the problem solving analysis documentation to one or more risk analysis documentation by using a set of rules for encoding documents in a format that is both human-readable and machine-readable (e.g. extensible markup language (XML)). With the use of XML to perform populating/transferring data between the documents, the quality management system is able to have two documents ether stored in the same database in tables, or different databases to communicate with each other and merge relevant data based on several key words and criteria.

For example, information associated with a problem solving analysis document (e.g. 8D) may have its contents transmitted to a risk analysis document using several methods including, but not limited to, searching the risk analysis documentation based on the part number listed in the problem solving analysis documentation and populating information from the 8D to the FMEA. Another example of the communication and linking between the two documents may include key words entered in the title, problem description, and/or concern details from the problem solving documentation and matched to an FMEA having the same key words.

The system may display several related risk analysis documents based on the key words, requirements, and part numbers associated with the risk analysis documentation. The system may automatically update the risk analysis documents based on the information in the problem solving documentation, or the system may allow a user to manual choose between a list of risk analysis documents generated by the system that contain the matched key words. For example, the user may select from a list of risk analysis documents which FMEA may be updated with the information discovered and recorded on the 8D problem solving document.

The engineering management system and process may allow users to identify and analyze risks associated with their designs and processes with the goal of preventing specific risks and improving quality. The system allows for knowledge management activities by using problem solving results to be recorded and applied to future product FMEAs including, but not limited to, child programs, minor product refresh, major product refresh, or a total redesign of the product.

For example, the engineering management system may allow knowledge management activities to recognize parent/child product relationship between one or more risk analysis documents and populate analysis information to the related documentations. This ensures that root cause analysis, lessons learned, and/or product improvements can pass on to related and future programs.

The knowledge management activities allow the information to be used throughout the entire life cycle of the product for continued use in product and process optimization, problem solving in product issues, and development of other related products and services. With the knowledge management activities, the system may mitigate specific risks through the design and redesign of their products and processes while controlling the manufacturing production process. The system allows for communication to several groups and organization within a company while also reducing the quality risk to the customer through the control of the production processes and prevention or detection of unacceptable results.

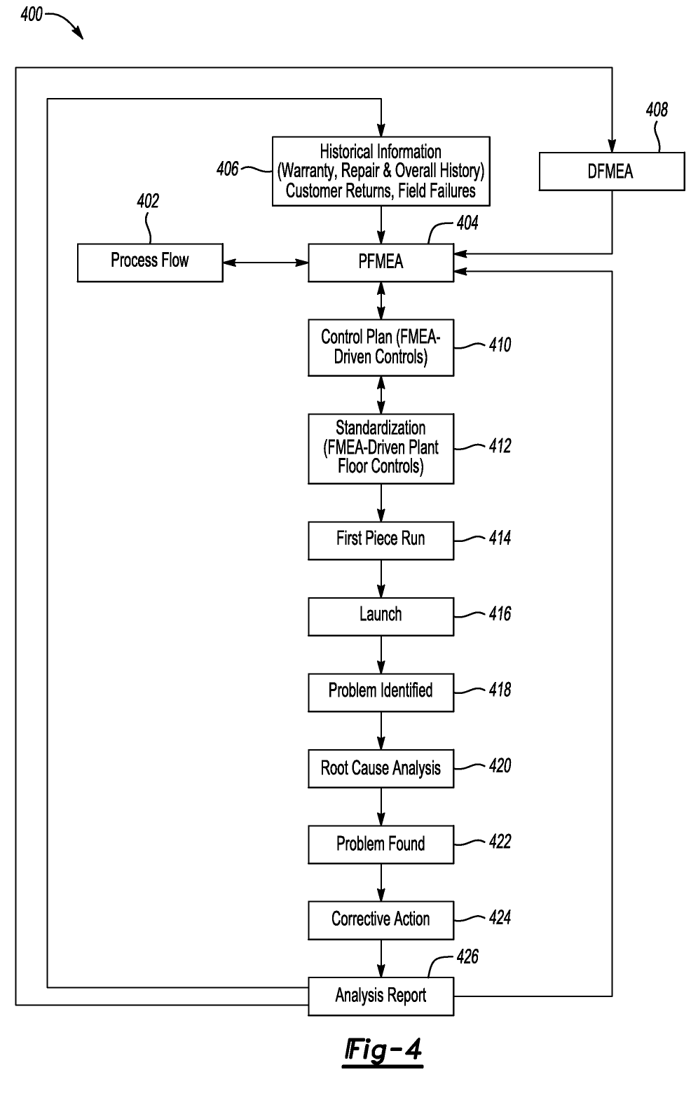

FIG. 4 is a block flow diagram illustrating a preferred implementation of process knowledge management 400 in accordance with one embodiment or aspect of present invention. The implementation of the process knowledge management system may define, document, and control the end to end product development process from the design stage to manufacturing. The knowledge management system provides a platform for continuous improvement for the product and/or process.

At step 402, the system may store one or more process flows related to a manufacturing of a product, system, and/or component. The system may develop a process failure mode effects analysis (PFMEA) based off the process flow entered into the system at step 404.

At step 406, the PFMEA may receive historical information stored in the database including, but not limited to, warranty data, repair history, customer returns, and/or field failures. The PFMEA may also receive information regarding design failure mode and effects analysis (DFMEA) at step 408. The system allows the correlation between the PFMEA and DFMEA creating the data generated by both risk prevention documents to influence each other. For example, the product may have an identified issue based on the DFMEA, however doing something different in the manufacturing process if it cannot be fixed by design alone may be identified therefore updating the PFMEA to capture this fix.

At step 410, the control plan may be developed based on the PFMEA, therefore preventing, mitigating, or controlling unfavorable outcomes in the manufacturing of the product. The system may improve the control plan by also allowing the historical information and DFMEA to be referenced with the PFMEA while developing the plan. The system may then develop the control plan to include the steps needed to control the process while maintaining the design requirements needed to eliminate product variation with the use of additional data including, but not limited to field failures, warranty and repair history taken into account by the PFMEA. The control plan may provide feedback to the PFMEA for continuous improvement of the product.

At step 412, the system may generate a standardization practices based on the control phase including, but not limited to quality control process charts, controls charts, and statistical process control. The standardization practices are FMEA driven plant floor controls to ensure the quality of a product or a service. The knowledge management allows for historical data and the DFMEA to be a part of the inputs when generating the standardization practices.

At step 414, the knowledge management system may receive inspection and test data of a pre-production sample to verify the manufacturing process while determining if the product meets acceptance requirements and quality control requirements. If the system approves the inspection and test data of a pre-production sample based on the control plan, the product may be ready for launch at step 416.

The knowledge system may continually collect data and transmit problem solving analysis results to risk prevention documents to ensure quality of the current product and future products. For example, after the launch and during production a problem may be identified on the product and the knowledge management system may be used to identify the problem at step 418. Once a problem presents itself in a product one or more problem solving analysis tools may be used to determine a root cause. The one or more problem solving analysis tools may include, but is not limited to, an effective problem solving method, eight disciplines, or a corrective action report format. A problem on a product may include, but is not limited to, a warranty issue, repair, customer returns, field failures, and/or manufacturing defects. The problem may occur based on a manufacturing process malfunction, design failure not identified during development, and/or incorrect specification/requirements of one or more components or subsystems in the product.

At step 420, the problem solving analysis tools may implement several techniques to determine one or more root causes of a failure in a product. The knowledge system allows several users with access to a terminal that may be connected using internet/intranet access for a web based application to communicate with a database storing the problem solving and risk prevention analysis documents. After the root cause analysis is complete, the system may allow one or more users to communicate with each other the problem found at step 422.

At step 424, a corrective action may be put in place based on the problem found using the one or more problem solving tools to identify a root cause. Once a corrective action is put in place, the system may transmit the information to several documents allowing a user to provide an analysis report on the problem that has been solved to others within an organization to learn and/or apply the corrective action to their product, process, and/or specification at step 426.

The knowledge management system may transmit the completed problem solving activity to one or more risk analysis documents based on specific information including, but not limited to part number(s), failure mode and causes, recommended actions and corrective solutions. For example, the system may receive the part number associated with the problem solving analysis and correlate it with other risk analysis documents that include the part number or a derivative of the part number. The specific information may be automatically added to the relevant areas of the risk analysis documents so a user may prevent potential failures in future products. The system may also calculate several statistics based on the information received from the problem solving analysis tools including, but not limited to, failure rate of the failure mode.

The knowledge management system may transfer the risk analysis information to other production products and processes to ensure communication of potential risks and how these risks have been reduced using one or more corrective actions.

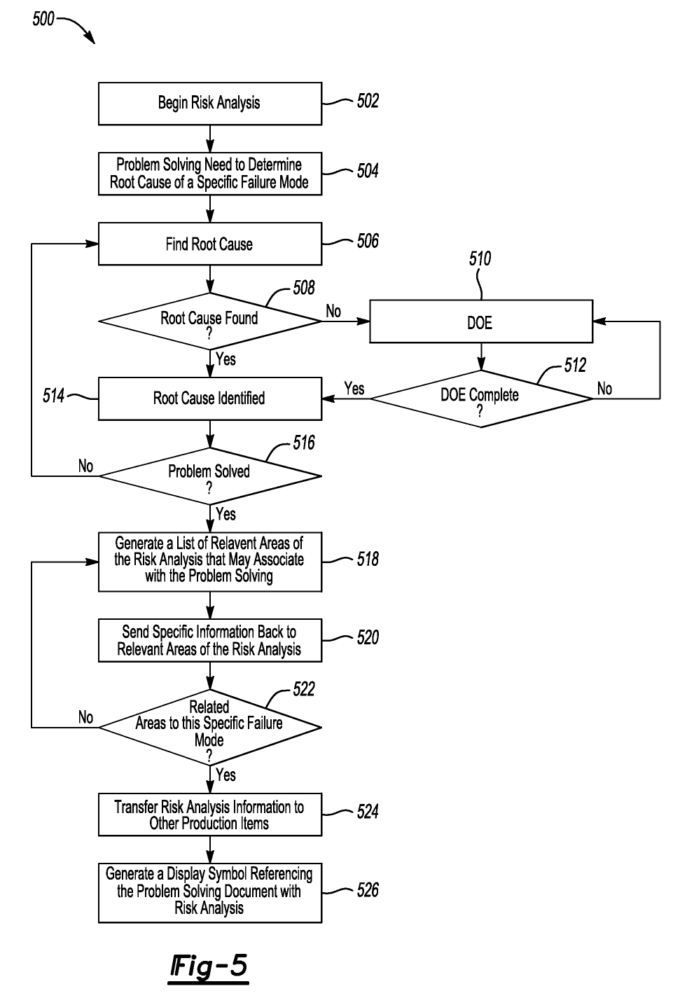

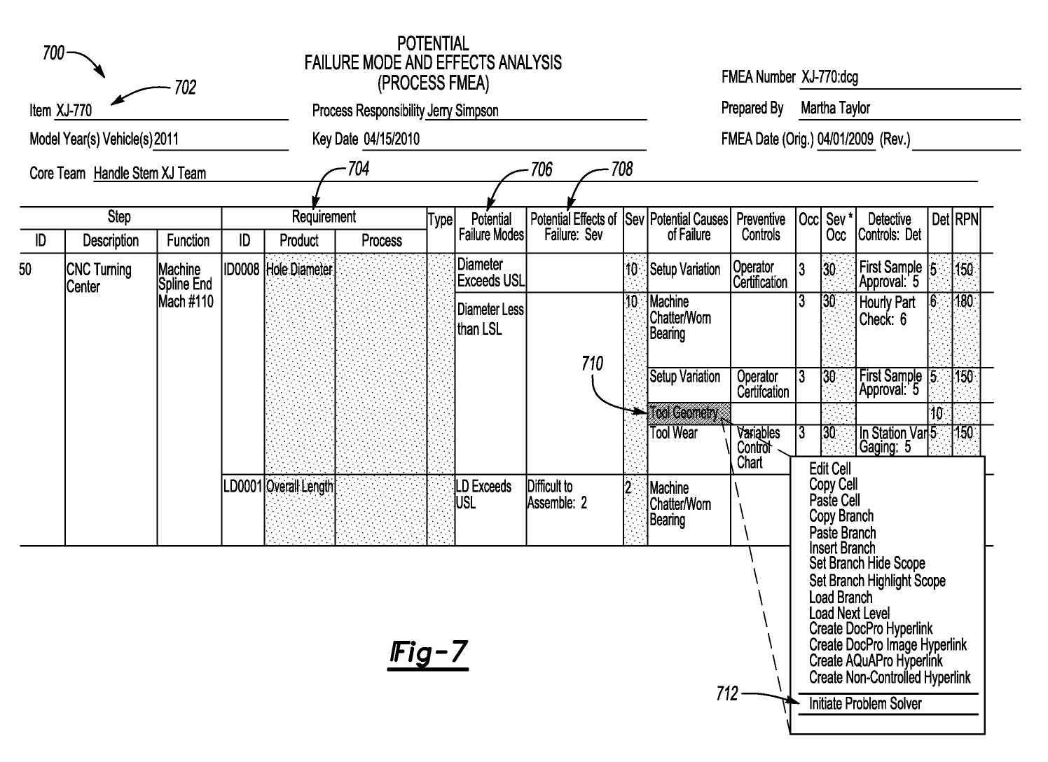

FIG. 5 is a flow chart for a quality management system that generates risk analysis documents with the integration of problem solving analysis methods for root cause investigation. The flow chart in FIG. 5, the screen shots and user interfaces illustrated in FIGS. 7-11 are referenced throughout the discussion of the method to facilitate understanding of various aspects of the present invention. The method of communicating problem solving analysis results to one or more risk analysis documents may be implemented through a computer algorithm, machine executable code, or software instructions programmed into a suitable programmable logic device(s) of a computer system, such as the processor, or a database in communication with computer system, or a combination thereof. For example, one or more processors may have additional instructions to implement several features of the quality management system. Although the various steps shown in the flowchart diagram 500 appear to occur in a chronological sequence, at least some of the steps may occur in a different order, and some steps may be performed concurrently or not at all.

At step 502, the system may allow a user to generate and manage one or more risk analysis documents. During the examination and study of the risk analysis document, the user may run into a failure mode that may need additional investigation to determine a better understanding of the potential problem/risk. The system may allow the user to launch one or more problem solving analysis methods to determine analysis and root cause of the failure mode in question at step 504.

At step 506, the system may allow the user to generate, manage, and update the launched problem solving analysis tool to determine a root cause initiated by a risk analysis document. The problem solving analysis method (e.g. 8D) may allow for one or more short term corrective actions potentially leading to identify the root cause of the problem. The root cause may be identified after minimal analysis, however if the root cause is not easily identifiable other analysis tools and method are required at step 508.

At step 510, if the root cause is not found, a problem solver may initiate a design of experiment (DOE) information gathering and problem solving exercise to determine the root cause. During the DOE analysis, the problem solver may have to add additional arising variables before determining control and intervening relationship between the variables at step 512.

At step 514, once the DOE and/or potential root cause analysis is complete, the problem solver may have identified the root cause of the problem. The results of the DOE and potential root cause corrective actions may be implanted to verify if the problem has been solved at step 516. If it is determined that the corrective actions implemented does not cure the problem, the system may begin another analysis at step 506.

At step 518, the system may generate a list of relevant areas of the risk analysis documents that may be associated with the problem solving analysis subject matter. The system may transmit the root cause investigation information to relevant areas of the risk analysis document(s) at step 520. For example, the system may automatically determine where the relevant problem solving information may be transferred to the risk analysis documents, or allow the user to manually select from a list of risk analysis documents related areas of interests. If the system determines that the problem solver analysis is related to a specific failure mode it may update related sections of the risk analysis document based on the information including, but not limited to, part numbers, corrective actions, root cause, statistical information, and process information. If the related areas to a specific failure mode are not related, the system may generate another list of relevant areas of the risk analysis that may associate with the problem solving analysis information.

The problem solving analysis information may be stored in a separate document with no linkage to the risk analysis document. The problem solving analysis information may be transmitted to one or more risk analysis documents using an a set of rules for encoding documents in a format that is both human-readable and machine-readable (e.g. XML schema) that may pull specific information form the problem solving document and submitted it into the risk analysis document at step 524.

At step 526, once the problem solving analysis document transmits specific information to the one or more risk analysis document, the system may generate a display symbol on both documents that creates a cross reference link to the respective document. The cross reference link allows a user to click on the display to open the respective document. For example, if the user is in the risk analysis document and clicks on the cross reference link associated with a failure mode, then the associated problem solving document related to that failure mode may open. In another example, if the user is in the problem solving document and clicks on a cross reference link related to a root cause analysis determined outcomes, then a related risk analysis document associated with the root cause analysis determined outcome may open.

At step 522, the system may determine if the problem solving subject matter is related to areas to specific failure modes in one or more risk analysis document (e.g. FMEA). If

[symbol]

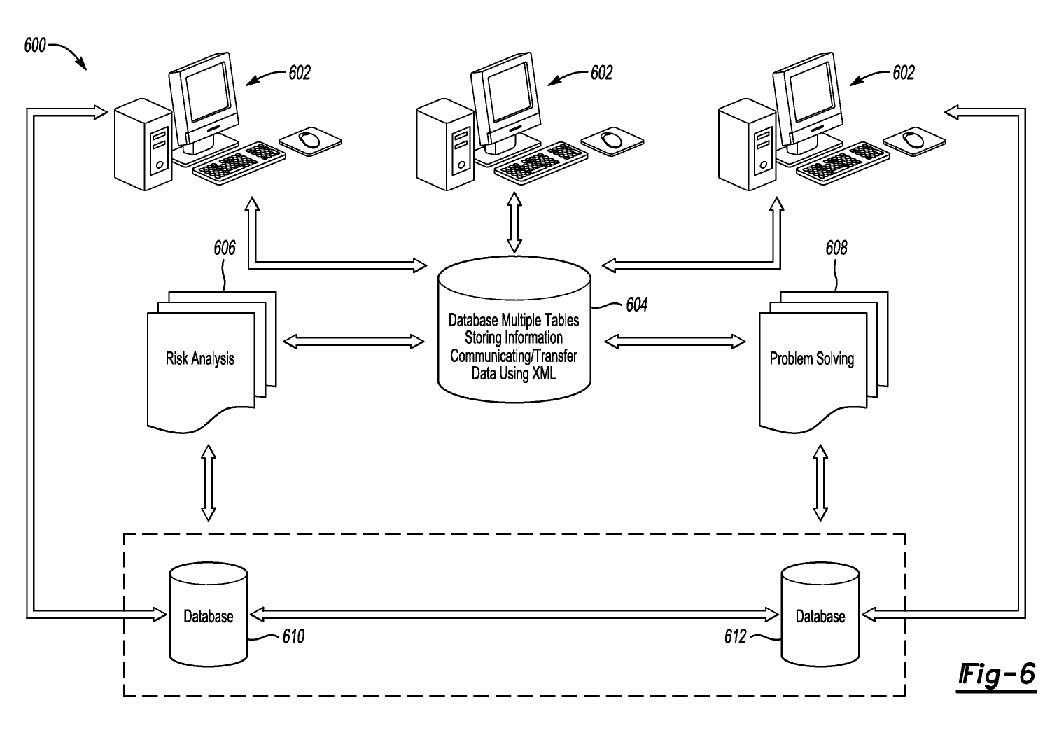

FIG. 6 is an exemplary block topology of a quality management system 600 implementing a multiple user-interactive display system. The quality management system may contain one or more user-interactive display systems 602 that may be located at the same or different facilities. The one or more user-interactive display systems 602 may retrieve several quality documents, reports, analysis results, tools, and other product related design, development, and process documents. The user-interactive displays may be implement in several ways including, but not limited to, a centralized database 604 storing several documents using multiple tables or several database 610, 612 in communication with one another, and/or both in combination.

The one or more user interactive displays 602 may access the database using several forms of communication including, but not limited to, an internet and/or intranet connection. The display systems may launch and/or run the quality management software on their device and/or run the software remotely using the internet/intranet connection to the database.

For example, a user may run the quality management system from a computer that has internet/intranet access to communicate with one or more databases where product information is stored. The user may launch several quality management tools and documents from the quality management system including, but not limited to, risk analysis tools 606 and problem solving tools 608. The risk analysis 606 tools may include, but are not limited to, DFMEA, PFMEA, and/or other design for six sigma analysis tools. The problem solving 608 tools may include global eight disciplines, the use of statistics, and/or histograms.

In another example, the user may discover while working on a DFMEA that a potential failure mode may not have a documented potential cause of failure based on several reasons including, but not limited to, the product may be introducing new technology, a new process, new software, and/or a new system/subsystem with a new failure mode. The user may launch a problem solver 608 from the DFMEA to identify the potential cause of failure for that potential failure mode. Once the user completes the problem solver analysis, root cause and corrective action(s) are identified and documented in the problem solver 608. Once the corrective and preventive actions have been verified, the problem solving 608 report is published and the data is merged with one or more risk analysis 606 document(s). The one or more risk analysis documents merged and populated with the data from the problem solver analysis tool are additional documents that may be related to the failure mode, part, subsystem, and/or system of the product.

The quality management software may allow the data from a problem solving 608 document to be merged into one or more risk analysis 606 documents by using a set of rules for encoding documents in a format that is both human-readable and machine-readable (e.g. an XML schema). The software may search for keywords including, but not limited to, part numbers, terms, requirements, product name, and/or process. The quality management system may allow for one database having multiple documents communicating with each other, and/or several databases in communication with one another to populate and merge documents that may have related topics and information.

FIG. 7 is an example GUI for identifying a potential cause of failure in a risk analysis document 700 that requires additional information to identify controls and root cause. The risk analysis document may include, but is not limited to, a potential failure mode and effects analysis for a manufacturing process of a product. The PFMEA may include the product item 702 with additional information including, but not limited to, model year, FMEA number, and the core team.

The PFMEA may include the process step, and related product requirement 704. Based on the manufacturing process and function, the user may determine one or more potential failure modes 706. Based on the one or more failure modes, the user may describe potential effects of the failure 708 and potential causes of the failure 710. If a user is unaware of potential effects and causes of the failure, the system allows the user to launch a problem solving device from the risk analysis document.

The user may right click on the identified potential causes of failure to bring up a list of options and in that list is the initiate problem solver 712. The user may select the initiate problem solver to open up one or more problem solving tools. The user may select form a list of problem solving tools made available.

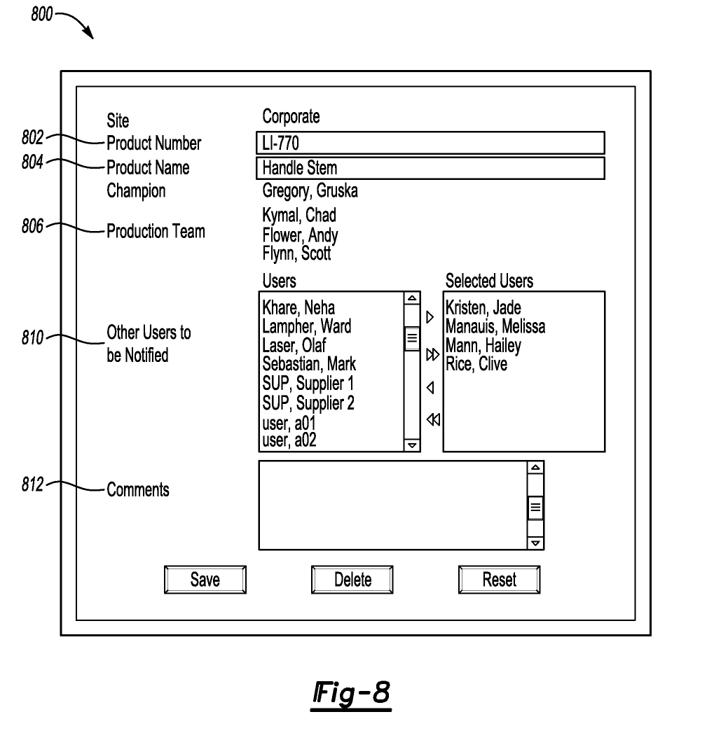

FIG. 8 is an example GUI for launching a problem solver analysis tool 800 from a risk analysis document to start a root cause analysis. The quality management system may allow the problem solver to be launched directly from the risk analysis document. Once the problem solver has been launched the software may allow information from the risk analysis document to be inserted into one or more relevant areas of the problem solving document including, but not limited to, the product number 802, product name 804, and/or the champion of the problem solving analysis.

The problem solver analysis tool may also allow the user to select others 810 to be notified that may be interested in the outcome of the root cause, preventive controls, and/or detective controls. The selected others 810 may be at a different location from the user and receive the problem solving analysis from their computer terminal having access to the quality management system. The quality management system may email one or more selected others to notify when certain stages of the problem solver analysis has been complete. For example, once a user has selected other users 810 to be notified, the system may send an email to the other users at certain event of the problem solving analysis (e.g. if a root cause has been determined).

The problem solving analysis tool may also allow comments 812 to be inserted at one or more sections of the analysis. The comment section 812 allows a user to insert certain information that may provide more details to assist others within the organization of a certain process/step of the analysis. The system may retrieve the information inserted in the comment section 812 of the problem solving document and insert the information into one or more risk analysis documents that may be related to the analysis based on certain keywords or numbers.

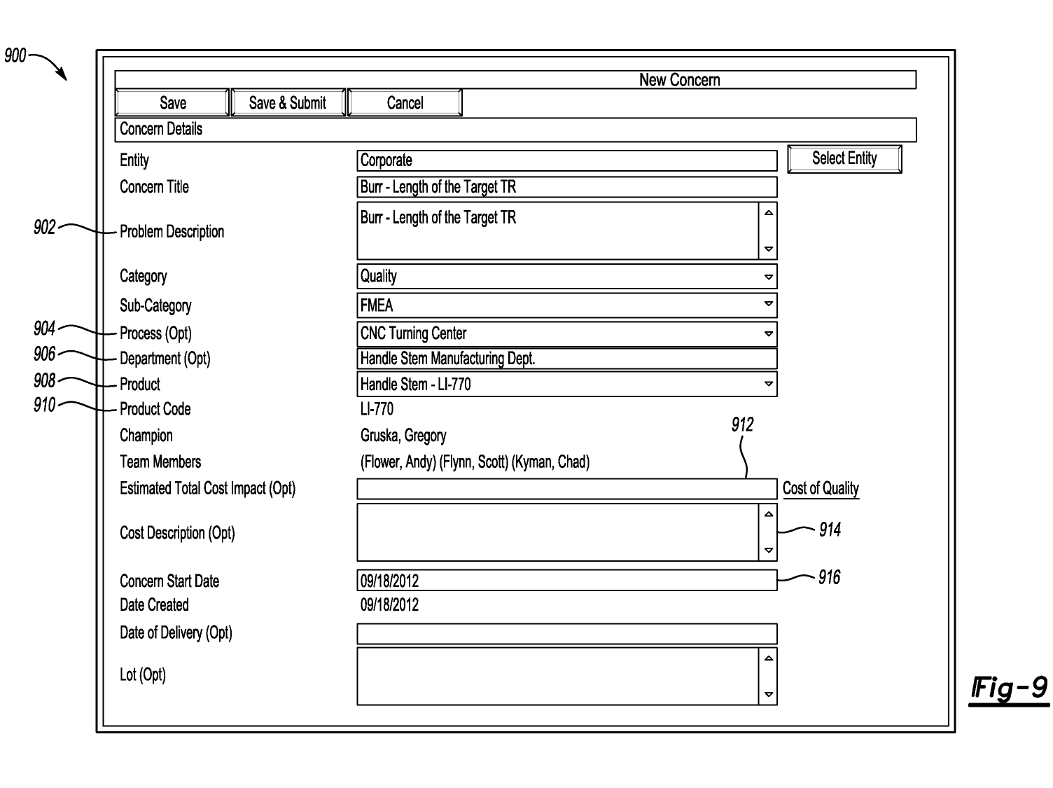

FIG. 9 is an example GUI for auto-populating information into the problem solver tool 900 from the risk analysis document. The system may auto-populate the problem description 902, process operation 904, related manufacturing department 906, product 908, and/or product code 910. This information provides the system to cross reference between additional problem solving documents and risk analysis documents when the analysis is complete. The margining of information between documents assures that quality data is communicated and not lost in one or more databases and allows for current or future product programs to use this data. The system allows for the cross referencing and merging of quality data so that other organizations within a product development business may learn from and to improve their process and product.

The auto-populating of information from the risk analysis document to the problem solver tool allows additional space were a user may manually fill in additional detail. The user may fill in additional detail on the problem solver GUI including, but not limited to, estimated total cost of impact 912, cost description 914, and/or the start date of the concern 916. There are several screens associated with the problem solver and risk analysis documents. Only a few screens are discussed to demonstrate examples on how the system and software works to cross reference, merge, and communicate information between the one or more documents.

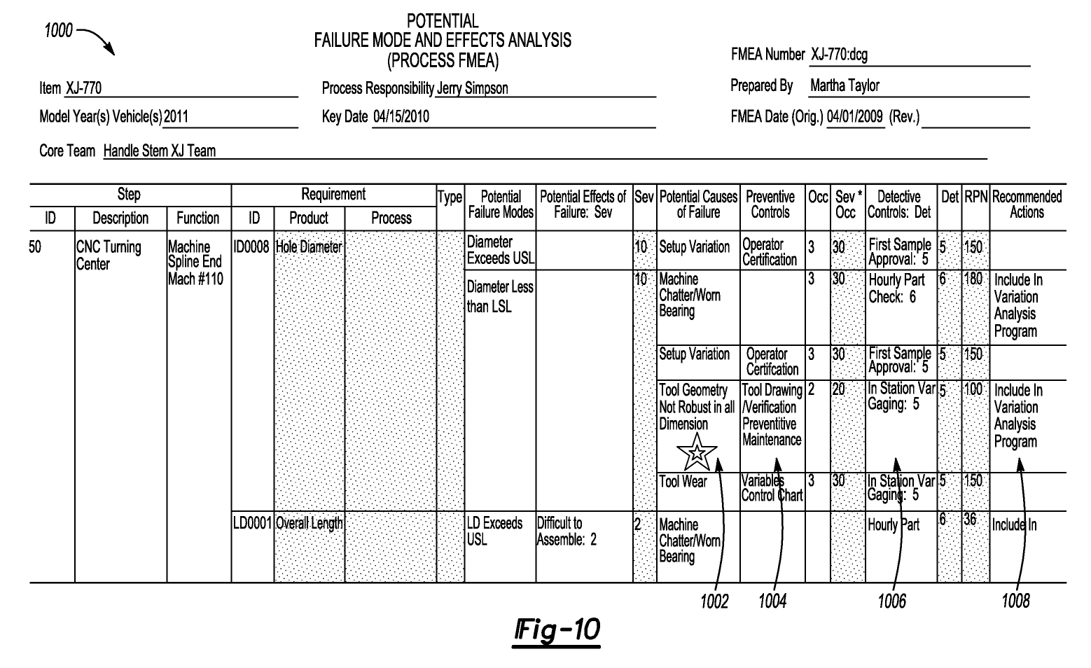

FIG. 10 is an example GUI for merging information from the problem solver document to one or more risk analysis documents 1000 and publishing a cross reference link indicated by an icon to cross reference the documents. The risk analysis document may receive information once a problem solving analysis is complete. The system may merge the information using software that is trained to look at keywords associated between the two documents including, but not limited to, process description, process function, requirement, failure mode, part number and/or in combination of the keywords.

The system may have one or more algorithms that are trained to merge information between the risk analysis document and the problem solving document. For example, the system may use a set of rules for encoding documents in a format that is both human-readable and machine-readable (e.g. XML) to format the documents in a structure that allows elements and certain content to be identified as information that may be merged between one or more documents. The system allows for communication and merging between the documents stored in one database or several databases.

The system allows the problem solver analysis results to be merged into the risk analysis document while allowing for a cross referencing link between the documents. The risk analysis document may populate information from the problem solver tool that includes, but is not limited to, potential causes of failure 1002, preventive controls 1004, detective controls 1006, and/or recommended actions 1008. Once the risk analysis document has received this information it may be able to statistically calculate the respective occurrence, detection, and related risk priority values. The system may create a link as illustrated by the star under the potential causes of failure 1002 to cross reference the problem solving document that is was generated based on that specific failure mode in the risk analysis document. The link may allow the two documents to be cross referenced for further assurance that the information and analysis generated from the problem solving analysis will not be lost for future programs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
one or more processors configured to:
receive input defining one or more requirements for a product;
generate a first risk prevention document based on one or more of the product requirements;
receive risk parameter input related to the first risk prevention document;
initiate a problem solver analysis tool based on the first risk prevention document;
receive problem parameter input related to the problem solver analysis tool;
determine one or more outputs using the problem solver analysis tool; and
populate one or more aspects of the first risk prevention document with the determined outputs based on one or more defined associations between the first risk prevention document and the problem solver analysis tool.

2. The system of claim 1 wherein the one or more processors are further configured to generate a cross reference link between the problem solver analysis tool and the first risk prevention documents based on one or more defined associations.

3. The system of claim 2 wherein the cross reference link may be displayed as an icon near a specific failure in the first risk prevention document.

4. The system of claim 1 wherein the one or more processors are further configured to retrieve one or more risk prevention analysis documents in addition to the first risk prevention document based on a relationship between the additional documents and the first risk prevention document; and populate the one or more risk prevention documents with determined outcomes based on defined associations between the risk prevention documents and the problem solver analysis tool.

5. The system of claim 1 wherein the one or more defined associations include product number, problem description, and concern details.

6. The system of claim 1 wherein the one or more processors are further configured to display the product requirements which have been analyzed in the risk prevention document using color coding based on user defined relationships between the analysis, documents, or both.

7. The system of claim 1 wherein the first risk prevention documents is a failure mode effects analysis.

8. The system of claim 7 wherein the failure mode effects analysis includes system, subsystem, design, process, and component failure mode affects analysis.

9. The system of claim 1 wherein the problem solver analysis tool includes global eight disciplines.

10. A non-transitory machine readable storage medium storing instructions that, when executed, cause a processor to perform a method comprising:
receive input defining one or more problems for a product;
generate a problem solver analysis tool based on one or more problems;
receive problem parameter input related to the problem solver analysis tool;
initiate a first risk prevention document based on the problem solving analysis tool;
receive risk parameter input related to the first risk prevention document;
determine one or more outputs using the problem solver analysis tool; and
populate one or more aspects of the first risk prevention document with the determined outputs based on one or more defined associations between the first risk prevention document and the problem solver analysis tool.

11. The non-transitory machine readable storage medium of claim 10 storing additional instructions, when executed, cause a processor to generate a cross reference link between the problem solver analysis tool and first risk prevention documents based on one or more defined associations.

12. The non-transitory machine readable storage medium of claim 11 wherein the cross reference link is displayed as an icon near a specific failure in the first risk prevention document.

13. The non-transitory machine readable storage medium of claim 10 storing additional instructions, when executed, cause a processor to retrieve one or more risk prevention analysis documents in addition to the first risk prevention document based on a relationship between the additional documents and the first risk prevention document; and populate the one or more risk prevention documents with determined outcomes based on defined associations between the risk prevention documents and the problem solver analysis tool.

14. The non-transitory machine readable storage medium of claim 10 wherein the defined associations include manufacturing process, process operation, and related manufacturing department.

15. The non-transitory machine readable storage medium of claim 10 storing additional instructions, when executed, cause a processor to display the product requirements which have been analyzed in the risk prevention document using color coding based on user defined relationships between the analysis, documents, or both.

16. A method comprising:
receiving input defining one or more requirements for a product;
generating a first risk prevention document based on one or more of the product requirements;
receiving risk parameter input related to the first risk prevention document;
initiating a problem solver analysis tool based on the first risk prevention document;
receiving problem parameter input related to the problem solver analysis tool;
determining one or more outputs using the problem solver analysis tool; and
populating one or more aspects of the first risk prevention document with the determined outputs based on one or more defined associations between the first risk prevention document and the problem solver analysis tool.

17. The method of claim 16 further comprising:
retrieving one or more risk prevention analysis documents in addition to the first risk prevention document based on a relationship between the additional documents and the first risk prevention document; and
populating the one or more risk prevention documents with determined outcomes based on defined associations between the risk prevention documents and the problem solver analysis tool.

18. The method of claim 17 wherein the populating additional risk prevention documents with determined outcomes is manually selected by a user.

19. The method of claim 16 further comprising generating a cross reference link between the problem solver analysis tool and the first risk prevention documents based on the one or more defined association.

20. The method of claim 19 wherein the cross reference link is displayed as an icon near a specific failure in the first risk prevention document.
